(19) United States
(12) Patent Application Publication
(10) Pub. No.: US 2022/0114460 A1
(43) Pub. Date: Apr. 14, 2022

(54) Apparatus of Identifying Heterogeneous Time-Series Data Expression with High Efficiency

(71) Applicant: National Central University, Taoyuan City (TW)

(72) Inventors: Chih-Yuan Huang, Taoyuan City (TW); I-Sheng Tseng, Taoyuan City (TW)

(21) Appl. No.: 17/084,890

(22) Filed: Oct. 30, 2020

(30) Foreign Application Priority Data
Oct. 14, 2020 (TW) 109135557

(51) Int. Cl. G06N 5/04; G06N 20/00

(52) U.S. Cl. CPC G06N 5/04; G06N 20/00

(57) ABSTRACT

An apparatus is provided for identifying representation. The representation is obtained for heterogeneous time series data. The apparatus comprises a model training device and a data classification device. Based on the requirements of compression rate and information loss, a most suitable time series representation is found out for a specific time series data. In particular, the model training device assesses each item of training time series data to evaluate the performance of various representations for thus identifying the most suitable representation for each item of the specific training time series data; and, then, the training time series data are clustered and the most representative time series data for each clustered data is determined. On receiving unidentified time series data, the data classification device computes the similarity between the unidentified time series data and each cluster representation for indirectly identifying the most suitable representation for the unidentified time series data.

### TECHNICAL FIELD OF THE INVENTION

The present invention relates to identifying representation for time series data, where, based on the requirements of compression rate and information loss, a most suitable time series representation is found out for specific time series data.

### DESCRIPTION OF THE RELATED ARTS

Time series data is a series of data obtained by measuring the same event type to be stored in chronological order. Time series data exists in many fields, such as fluctuations in stock market, sensor data, medical and biological information, etc. The characteristics of time series data including continuous data production, high dimensionality, and huge amount of data. If the original time series data are directly used for analysis and storage, the efficiency is low and the cost is high. Hence, for effectively managing time series data, time series representation is used to replace original time series data to reduce the amount of data and dimensions thereof while the characteristics are retained at the same time. However, in terms of the performance of compression rate and information loss of the time series data representation, different time series representations are suitable for some specific time series types. Besides, the types of time series data are wide and diverse, which include temperature, humidity, speed, position, shock, pressure, etc. This means that it is not possible to effectively manage all types of time series data by using a single representation.

For solving the problem of high dimensionality, many time series data representations have been proposed. Yet, different time series representations have their own characteristics; and the types of time series data are wide and diverse, which include temperature, humidity, speed, position, shock, pressure, flow, gas, etc. This means that it is not possible to effectively manage all types of loT (Internet of Tings) time series data by using a single representation. Besides, the use of time series representation will inevitably cause the loss of some data characteristic; hence, it is an important issue to strike a balance between compression rate and distortion of data.

It is not possible to obtain a single representation having the best efficiency on all time series data. The most straightforward solution for determining the most suitable representation is to directly check all possible representations on receiving new time series data. Although guaranteeing on finding the most suitable representation, this prior art is very time-consuming on testing different time series representations one by one as dealing with a large amount of time series data. Because existing studies mostly use a single or specific time series dataset to compare several time series representations, there is an urgent need for improving the existing deficiencies. Hence, the prior arts do not fulfill all users' requests on actual use.

### SUMMARY OF THE INVENTION

The main purpose of the present invention is to, based on the requirements of compression rate and information loss, finding out a most suitable time series representation for specific time series data.

Another purpose of the present invention is to, on identifying the most suitable representation, obtaining an efficiency 17 to 300 times faster than prior arts with a scalability 10 times to those of the prior arts.

Another purpose of the present invention is to, under different settings of parameters, identifying the most suitable representation for 46 percent (%) to 76% of the time series data, where the representation selected for the rest time series data has a difference smaller than 2.19% to the actual most suitable representation.

To achieve the above purposes, the present invention is an apparatus of identifying representation with high efficiency for heterogeneous time series data, comprising a model training device, where a suitability score is obtained with a weighted sum of compression rate and information loss to evaluate the performance of various time series representations for each training time series data to thus identify a most suitable time series representation for each item of the training time series data; and, then, the training time series data are clustered and most representative time series data is determined for each item of the training time series data clustered; and a data classification device, where the data classification device connects to the model training device; on receiving new time series data unidentified, a comparison with the representative time series data is processed to compute similarity between the new time series data and each item of the representative time series data of clustered data through distance measure to classify the new time series data; and the most suitable time series representation is thus indirectly identified for the new time series data. Accordingly, a novel apparatus of identifying representation with high efficiency for heterogeneous time series data is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the structural view showing the preferred embodiment according to the present invention;

FIG. 2 is the view showing the normalization of the time series data;

FIG. 3 is the view showing the compression rates of the coefficient time series datasets;

FIG. 4 is the view showing the information losses of the coefficient time series datasets;

FIG. 5 is the flow view showing the clustering process;

FIG. 6˜FIG. 8 are the views showing the cluster prototypes obtained under the first, the second, and the third weight settings;

FIG. 9 is the view showing the original actual time series data;

FIG. 10 is the view showing the efficiency of the present invention and the naive approach;

FIG. 11 is the view showing the analysis of dynamic time warping (DTW) of the time series data having different lengths but the same characteristics;

FIG. 12 is the view showing the classified actual time series data;

FIG. 13 is the view showing the numbers of the most suitable training time series data for the representations under the different weight settings;

FIG. 14 is the view showing the numbers of the clustered data for the representations under the different weight settings;

FIG. 15˜FIG. 17 are the views showing the result accuracies of the test time series data for the different weight settings; and

FIG. 18˜FIG. 20 are the views showing the result accuracies of the actual time series data for the different weight settings.

### DESCRIPTION OF THE PREFERRED EMBODIMENT

The following description of the preferred embodiment is provided to understand the features and the structures of the present invention.

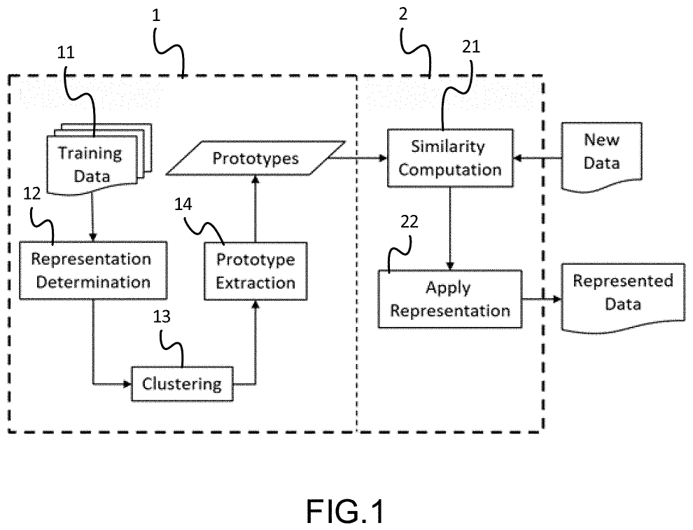

Please refer to FIG. 1 to FIG. 20, which are a structural view showing a preferred embodiment according to the present invention; a view showing normalization of time series data; a view showing the compression rates of coefficient time series datasets; a view showing the information losses of coefficient time series datasets; a flow view showing a clustering process; views showing cluster prototypes obtained under a first, a second, and a third weight settings; a view showing original actual time series data; a view showing the efficiency of the present invention and a naive approach; a view showing an analysis of DTW of time series data having different lengths but the same characteristics; a view showing classified actual time series data; a view showing the numbers of most suitable training time series data for representations under different weight settings; a view showing the numbers of clustered data for representations under different weight settings; views showing the result accuracies of test time series data for different weight settings; and views showing the result accuracies of actual time series data for different weight settings. As shown in the figures, the present invention is an apparatus of identifying representation with high efficiency for heterogeneous time series data, where the apparatus efficiently determines the most suitable representations for different types of time series data. The main technology of the apparatus is the following: The most suitable time series representations for training time series data are identified in advance; and, then, through computing similarity between new time series data and the training time series data, a most suitable time series representation of the new time series data is thus indirectly identified. As compared with the prior art of examining all possible representations for new time series data, the present invention achieves high efficiency as an important feature on considering the fast growth of abundant heterogeneous time series data. The apparatus comprises a model training device [1] and a data classification device [2].

The model training device [1] obtains a suitability score with a weighted sum of compression rate and information loss to evaluate the performance of various time series representations for each item of training time series data, so that a most suitable time series representation is identified for each item of the training time series data; and, then, for improving efficiency, the training time series data are clustered and most representative time series data for each clustered data are determined. Therein, because the behaviors of time series data have great diversity, the present invention collects training time series data in various fields as widely as possible.

The data classification device [2] connects to the model training device [1]. On receiving new time series data unidentified, a comparison with the representative time series data is processed to compute similarity between the new time series data and each item of the representative time series data of the clustered data through a distance measure for classifying the new time series data; and the most suitable time series representation is thus indirectly identified for the new time series data. Thus, a novel apparatus of identifying representation with high efficiency for heterogeneous time series data is obtained.

On using the present invention, the model training device [1] comprises a training data unit [11], a representation determination unit [12] connecting to the training data unit [11], a clustering unit [13] connecting to the representation determination unit [12], and a prototype extraction unit [14] connecting to the clustering unit [13]. The data classification device [2] comprises a similarity computation unit [21] and a representation execution unit [22] connecting to the similarity computation unit [21].

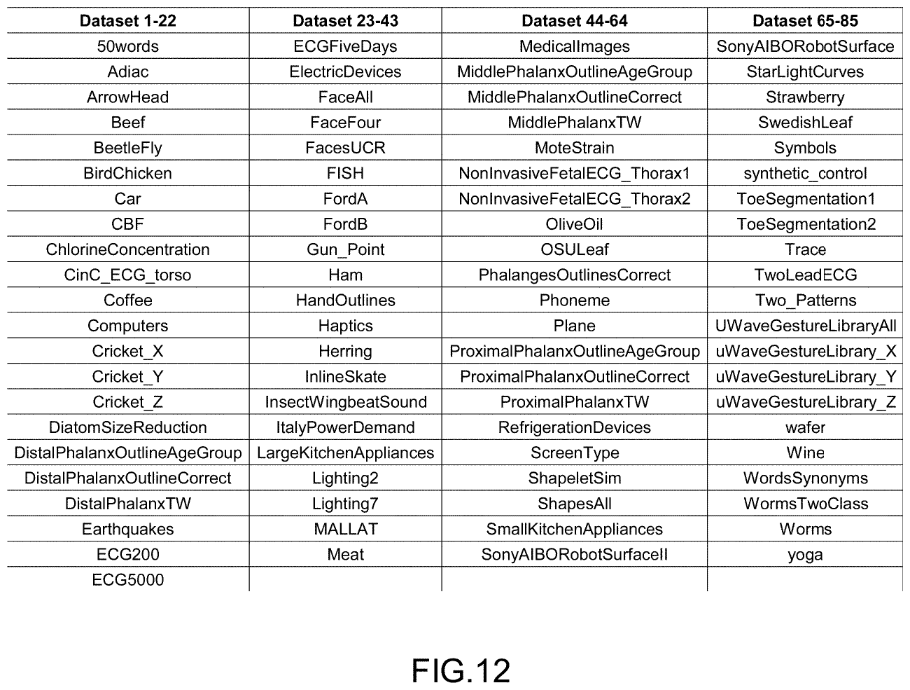

The present invention uses 85 time series data from a time series classification database of University of East Anglia (UEA) and University of California Riverside (UCR). The 85 time series data are collected from records of various fields, such as biology, medicine, image identification, food science, motion detection, sensor, etc. The training data unit [11] provides each time series with training datasets and testing datasets through the time series classification database; and the training datasets are used as training time series data for evaluation with the testing datasets. The time series classification database of UEA and UCR provides a few different training time series datasets, where FIG. 12 shows the names of the 85 time series data.

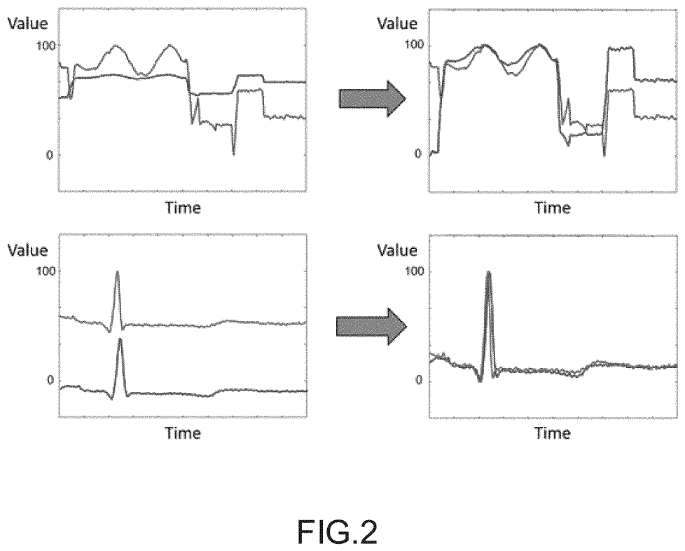

Before the training data unit [11] processes the training time series data, normalization of minimum and maximum is processed to normalize values of the training time series data into a range of 0˜100 to keep the amplitudes and offsets of the values of the training time series data unchanged within the range. Therein, if two training time series data are measured with different amplitudes or offsets, calculated distances thus obtained would not have the same baseline for comparison. Hence, before processing distance measure, normalization is required. For controlling the baseline, the values of the training time series data are normalized into the range of 0˜100, where, as shown in FIG. 2, Chart (a) shows amplitude normalization and Chart (b) show offset normalization.

Normalization of minimum and maximum is processed for linear conversion of the original training time series data. On normalizing values into a given range, say 0 to 100, the normalization of minimum and maximum only enlarges or reduces the values of the training time series data within the range without changing its shape. For mapping the values X in the original range of [Xₘᵢₙ, Xₘₐₓ] to the values X′ in the new range of [X′ₘᵢₙ, X′ₘₐₓ], the normalization of minimum and maximum is practiced through the following formula:

$${X}^{′} = \frac{X - {X}_{min}}{{X}_{max} - {X}_{min}} \times ( {X}_{max}^{′} - {X}_{min}^{′} ) + {X}_{min}^{′} . \qquad Formula ( 1 )$$

As described before, some independent research shows that, for a certain time series types (e.g. periodic, mutated, irregular, etc.), some various time series data representations are better than other time series data representations. Two factors are usually used to evaluate the performance of time series representation, i.e. reduced data size and lost data amount. These two factors are compression rate and information loss, which have been used to verify the effectiveness of time series data representation.

The compression rate is defined as the percentage of reduced data for the time series representation, which has a range of 0˜100 while a higher value means a higher compression rate. The following formula is used to compute the compression rate:

$$Compression rate = ( 1 - \frac{representation data size}{orignal data size} ) . \qquad Formula ( 2 )$$

On the other hand, information loss means the data lost after compression, which is the distance between the representative data and the original data. The distance between time series data is estimated through Manhattan distance measure, where the smaller is the distance, the smaller is the information loss. Therein, the reason for using the Manhattan distance measure is that it is intuitive while the difference between time series data at each time point is calculated only. It is different from the other distance measure requiring extra calculation of Lₚ-norm; and, as compared with DTW, the Manhattan distance measure uses a consistent baseline for calculation, while DTW tries to identify the best mapping between two time series data.

The following formula shows the equation used to estimate information loss, where, by normalizing the values of the time series data into a range of 0˜100, the information losses are also fitted into the range of 0˜100 while the larger is the value of time series data, the greater is the information loss:

$$Information loss = \frac{{\sum }_{i = 0}^{n} ( \vert Ra {w}_{i} - R e {p}_{i} \vert )}{n} ; \qquad Formula ( 3 )$$

and where Raw and Rep are separately the original time series data and the time series data with length n; and Rawᵢ and Repᵢ are separately the i^{th} value of Raw and Rep.

For determining the most suitable time series representation, the present invention uses six time series representations through the representation determination unit [12], which representations comprises a discrete Fourier transformation (DFT) representation, a discrete cosine transformation (DOT) representation, a piecewise aggregate approximation (PAA) representation, a piecewise linear aggregate approximation (PLAA) representation, an adaptive piecewise constant approximation (APCA) representation, and a discrete wavelet transform (DWT) representation. Each item of the training time series data are tested with four data lengths (128, 256, 512, and 1024) and five coefficients (2, 4, 8, and 16) for providing a comprehensive analysis of various time series representations. On evaluating the suitability of each one of the time series representations corresponding to each item of the training time series data, there are 20 combinations appears. Due to the need to strike a balance between the compression rate and the information loss, for estimating the reliability of the training time series data and obtaining a stable time series representation, the present invention computes the average value of 20 compression rates and 20 information losses to show the performance of one of the time series representations corresponding to one item of the training time series data.

The present invention designs a simple weighted-sum calculation to compute a suitability score by applying the two weights of compression rate and information loss as shown in the following formula, whose suitability score is within a range of 0˜100:

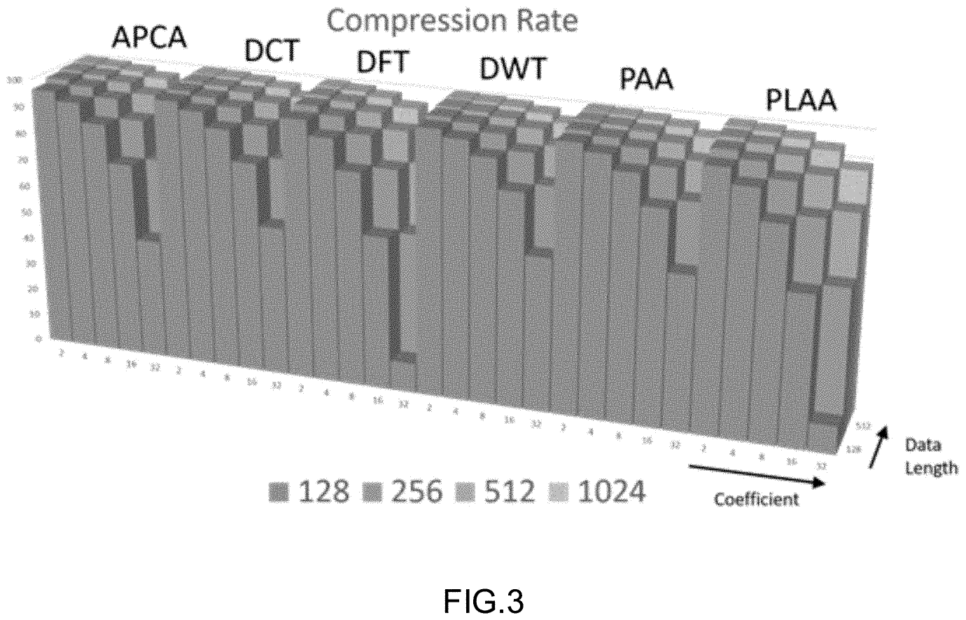

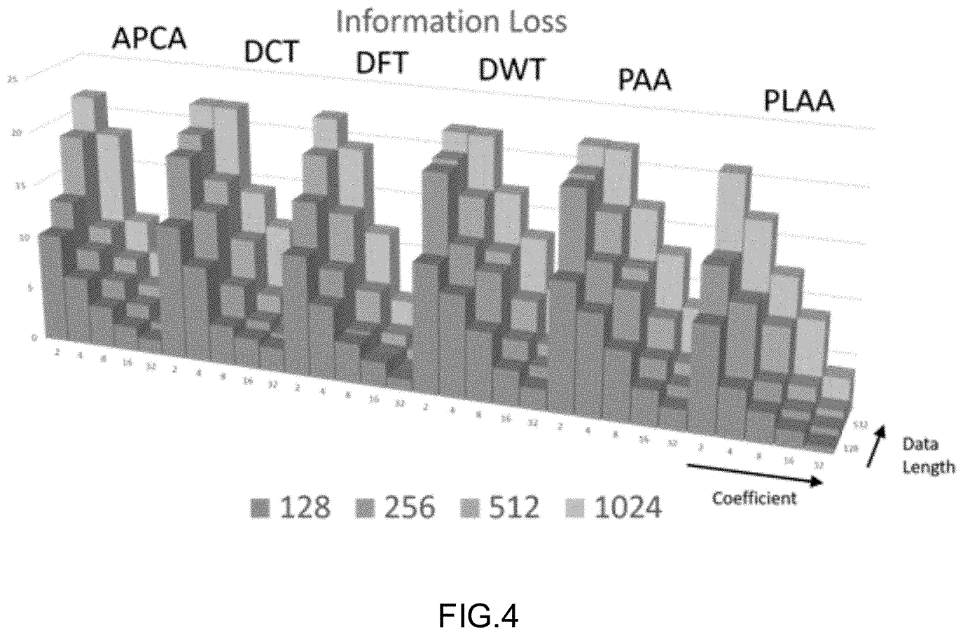

Suitability score=W_{com}*Average_{com}+W_{inf}*(100−Average_{inf}) Formula (4),

where W_{com} and W_{inf} are separately the weights of compression rate and information loss within a range of 0˜1 along with a required sum of 1; and Average_{com} and Average_{inf} are average compression rate and average information loss of time series representation. As shown in FIG. 3 and FIG. 4, the value ranges of compression rates have about 4 to 5 times of difference to those of information losses, where the compression rate usually reaches 90 percent (%) and the information loss is usually less than 25%. Hence, these two factors of weight must be setup very carefully. At last, one of the time series representations having the biggest suitability score is thus identified as the most suitable time series representation.

As described above, the main technology of the present invention is to find the most suitable training time series data for new time series data while their most suitable time series representations are assumed the same. As compared with the prior arts of determining the most suitable representation through directly examining all possible representations, the proposed present invention is more effective. Because a most suitable time series representation has been identified for each training time series data, the distance between the new time series data and the training time series data can be directly computed to, thus, identify the most suitable time series representation for the new time series data. But, because more training time series data might be required, the present invention clusters the training time series data through the clustering unit [13] to reduce the amount of similarity computations for further improving the efficiency.

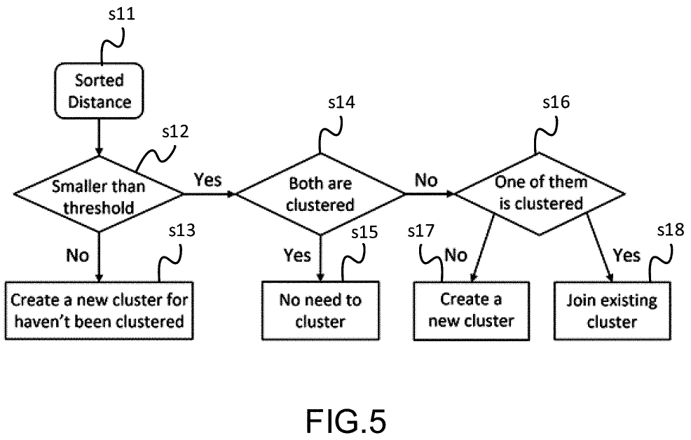

Generally speaking, the main purpose of clustering is to group time series data having the same characteristics into the same clustered data to avoid unnecessary similarity calculations. Before processing clustering, each item of the training time series data is grouped based on the most suitable time series representation thereof so that all of the training time series data in the same clustered data have the same suitable time series representation. Then, a distance measure of DTW is processed to identify the training time series data having similar characteristics. The clustering of the clustering unit [13] has a processing flow as shown in FIG. 5, where the processing flow follows the process of aggregated hierarchy grouping.

At first, in step [s11], DTW distances between the training time series data and sorted distances are calculated in ascending order, which means that the process starts from a small distance to a large distance. In step [s12], a threshold is defined to judge whether two training time series data are similar enough for finding a balance between efficiency and accuracy by adjusting the threshold, where a larger threshold means a lower requirement of the similarity between the two training time series data. The number of clustered data will also be reduced to increase efficiency, but it may lead to reduced accuracy, vice versa. In step [s13], a distance greater than the threshold means that the two training time series data are not similar and, then, the apparatus will create new clustered data for the training time series data that have not yet clustered. In step [s14], if a distance is smaller than the threshold, the apparatus will check whether the two training time series data have been clustered. If yes, clustering is not necessary, as in step [s15]. Yet, in step [s16] and step [s17], if the two training time series data are not clustered, the apparatus will group them into the same clustered data. Or, in step [s18], if there are only one of the training time series data that have not been clustered, the apparatus will add this training time series data to the clustered data which the other training time series data belongs to.

The clustering flow processed by the clustering unit [13] is processed mainly for reducing the size of training datasets through collecting similar time series data. Because the training time series data in the same clustered data are similar enough, they can be represented by a single training time series data. In particular, the prototype extraction unit [14] finds the most representative time series data for each clustered data.

Once the representative time series data is identified, only one new time series data is required to be compared with those representative time series data, where the comparisons with all training time series data are not necessary and, thus, the complexity of the apparatus is greatly reduced. In the prototype extraction unit [14], the present invention uses a medoid as a prototype for each clustered data to retain the characteristics of the training time series data. On retrieving the prototype, the training time series data in the clustered data are given to compute the distances between each two items of the training time series data. In all of the training time series data, an item of the training time series data having the smallest sum of distance to all of the other items of the training time series data is defined as the center of the clustered data; and, thus, a most representative time series data is found out for each item of the clustered data.

As described above, the present invention aims to propose an apparatus, where the apparatus effectively and adaptively identifies a most suitable time series representation for each item of the training time series data; and, by following what has been described above, the most suitable representation is determined for each item of the training time series data and the size of the training time series data is reduced through clustering and prototype extraction. Hence, on compressing a new time series data, the training time series data are classified through calculating similarity to cluster prototypes by using the similarity computation unit [21] for thus indirectly identifying the most suitable time series representation for the new time series data.

On calculating the similarity between the new time series data and the representative time series data (i.e. prototype), time series conversion will occur, such as time warp, offset, and zooming. Therefore, the distance measure of DTW is used to calculate similarity. Thereafter, the new time series data is considered to have the same behavior as the most similar representative time series data. Since the model training device [1] has determined the most suitable time series data representation for each training time series data, the most suitable time series representation for the representative time series data is also considered as the representation most suitable to the new time series data. At last, the representation execution unit [22] uses the identified time series representation to process compression to the new time series data.

The main course of the present invention is to propose a high-efficiency apparatus for identifying a heterogeneous time series representation. The apparatus can efficiently and adaptively select the most suitable timing data representation for each time series data. For proving the efficiency of the present invention, the following describes model training result, accuracy analysis, and efficiency analysis of comparing the present invention with prior art. However, the following embodiments are only examples to understand the details and contents of the present invention but not to limit the scope of patent of the present invention.

### (A) Model Training Result

### [Measure Result of Representation]

The present invention uses 85 time series datasets from the time series classification database of UEA and UCR as training data. At first, according to the suitability score defined in the above Formula (4), the most suitable representation is determined for each item of training time series data. To illustrate the different weight requirements between compression efficiency and information loss, the present invention applies three weight settings in the calculation of suitability score:

W_{com}=1,W_{inf}=0; (1)

W_{com}=0.5,W_{inf}=0.5; and (2)

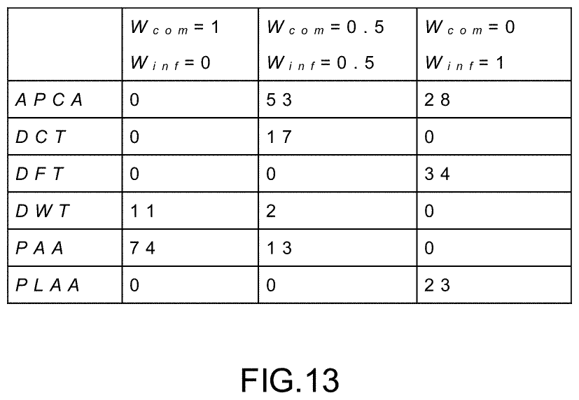

W_{com}=0,W_{inf}=1, (3)

where the ranges of these two weights are both from 0 to 1; and their sums must be individually equal to 1. The first setting determines the most suitable representation by only considering the compression efficiencies of different representations; the second setting considers both compression efficiency and information loss; and the third setting only considers information loss. The results of the three different weight settings for determining the representations are shown in FIG. 13, which shows the number of time series data most suitable for training with each one of the representations.

According to FIG. 13, with the first setting, PAA is the most suitable representation for 74 training time series data, and DWT is the most suitable representation for 11 training time series data. Since PAA uses only one value to form the coefficient as different from the other representations (i.e. APCA, DFT, and PLAA) on using two values to form coefficients, the PAA representation achieves a higher compression rate than the other ones.

With the second setting, APCA is better than the other representations. An APCA coefficient comprises two values, where one value is the length of an integer segment and the other value is an average value of each segment. This means that APCA requires more storage space than DCT, DWT, and PAA. Nevertheless, the data represented by APCA is more consistent with the original data (I.e. less information loss). DFT and PLAA use two non-integer values on forming a coefficient, so that their compression rates are lower than the other representations.

With the third setting, if information loss is considered only, a representation with two-value coefficient is better than a representation with one-value coefficient (i.e. DCT, DWT, and PAA). Because a representation with two-value coefficient has more information to represent time series data, the data represented usually have higher similarity than the original data. After determining the most suitable representation for each training time series data, the present invention then clusters the training time series data with the same most suitable representation.

### [Result of Clustering and Prototype Extraction]

If training time series data collected have similar time series types, clustering is processed to the training time series data having similar types to avoid repeating calculations in subsequent steps for further improving efficiency. The clustering also applies the above three different weight settings.

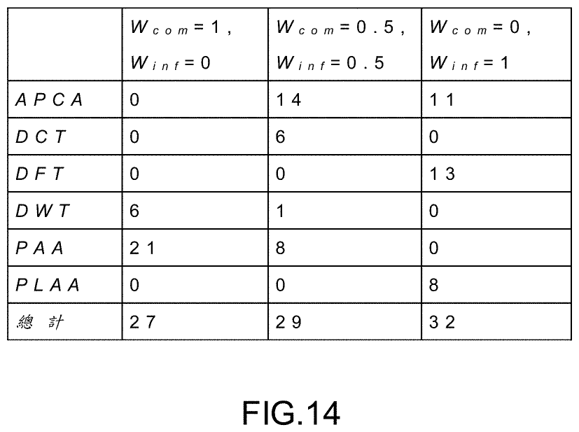

In the clustering, the present invention uses the size of 128 data points with a threshold of 250. Because DTW calculates the distances of the entire time series data, the threshold can be divided by the data length to obtain an average difference between two time series data. Because the size of data points and the threshold are user-defined, the threshold of an ideal clustered data is user-determined for the experiment result. The item number (threshold=250) of clustered data under different weight settings are shown in FIG. 14.

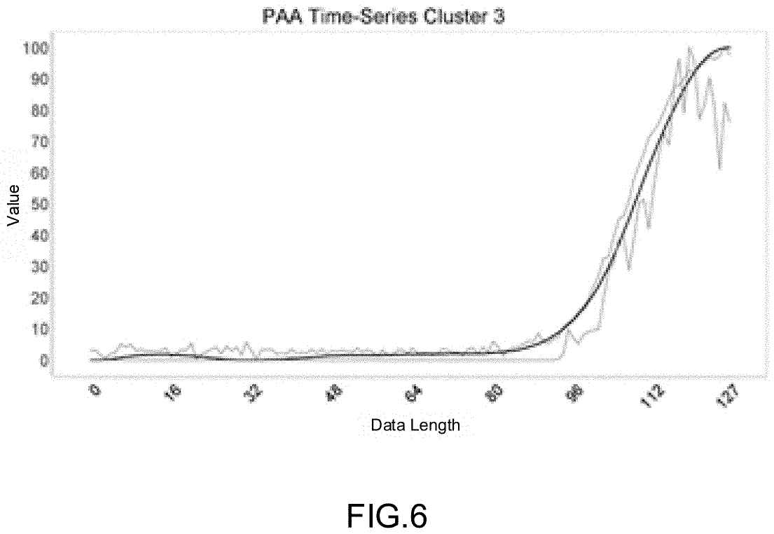

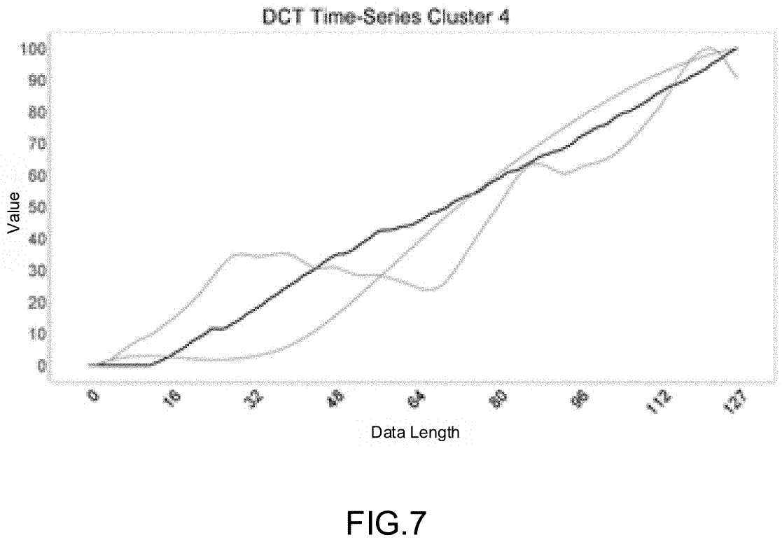

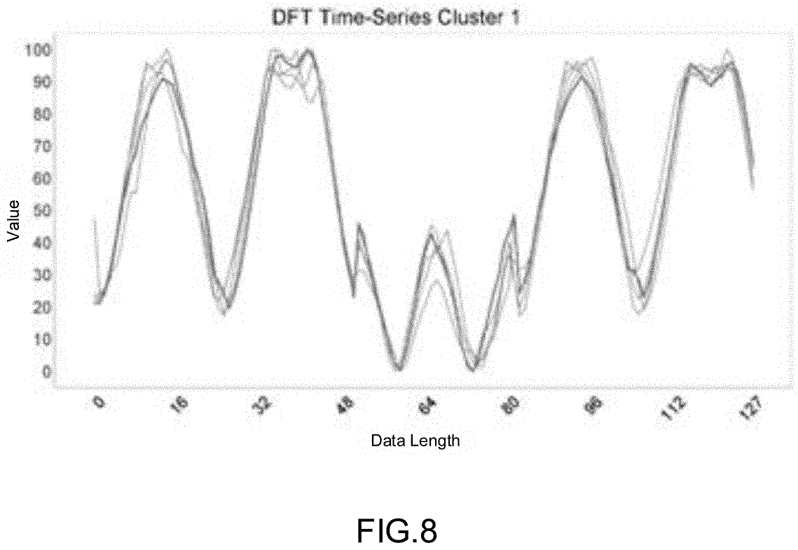

The number of clustered data shows how many different time series types in the same suitable representation. Under the first setting, there are 27 different time series types, where DWT is suitable for 6 types of time series data and PAA is suitable for 21 types of time series data. Under the second setting, there are 29 different time series types, where APCA is suitable for 14 types of time series data; PAA is suitable for 8 types of time series data; DCT is suitable for 6 types of time series data; and DWT is suitable for 1 type of time series data. Under the third setting, there are 32 different time series types, where DFT is suitable for 13 types of time series data; APCA is suitable for 11 types of time series data; and PLAA is suitable for 8 type of time series data. After the clustering, a prototype is generated for each cluster. FIG. 6, FIG. 7, and FIG. 8 shows individual clusters under the three weight settings, where each black line is an identified prototype in a cluster and gray lines are the other time series data in the same cluster.

### (B) Accuracy Analysis

### [Data Test of UEA and UCR Time Series Database]

The present invention uses 85 time series datasets of the time series classification database of UEA and UCR. In the database, training datasets and testing datasets are provided for every time series datasets. This test uses all 85 training time series datasets for model training. For accuracy analysis, 6 items are randomly selected from each one of the test time series datasets, where the length of each item of the test sequence data is 128. The present invention applies a total of 510 different items of the time series data in the database to examine the accuracy of the present invention under the three weight settings.

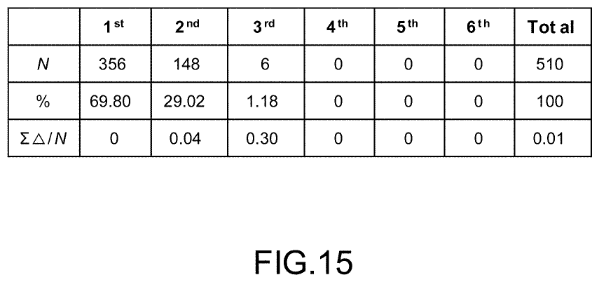

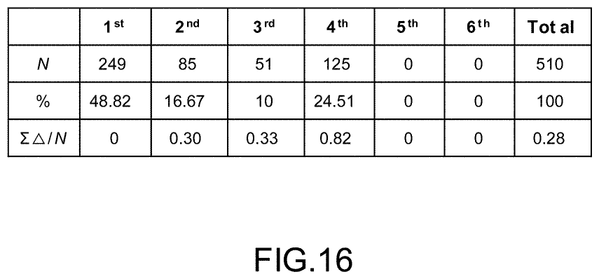

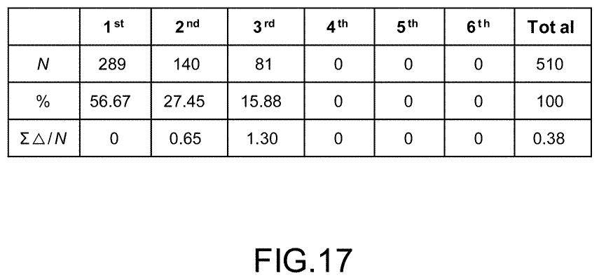

Every test time series data are regarded as time series inputs for the present invention. The present invention determines a most suitable representation for each item of the test time series data and, then, the result obtained through the present invention is compared with a verified result. The verified result is generated through a determining process under the same representation having the same parameter setting yet having only one data length of 128. This simple process identifies a most suitable representation for each item of the test time series data under the same parameter setting. The results of accuracy analysis under the three different weight settings for UEA and UCR time series classification database are shown in FIG. 15, FIG. 16, and FIG. 17, where 1^{st} is the most suitable representations selected for the time series data by the present invention, and 2^{nd} is the second suitable representations, so on and so forth; N is number of time series data; percentage symbol (%) is percentage of time series data in each type; and delta symbol (Δ) is suitability-score difference as compared with most suitable representation.

As shown in FIG. 15, the present invention has a 69.8% chance to select the most suitable representation for time series data. For the rest 31.2% of the time series data, an evaluation result shows that the selected representation produces a result with a suitability-score difference less than 0.3. The suitability score under the first setting considers compression rate only; hence, as compared with the most suitable representation, the compression rate provided by the present invention has a difference less than 0.3%.

According to FIG. 16 and FIG. 17, the present invention has 48.82% and 56.67% chances to select the most suitable representation for time series data. Once the present invention does not select a most suitable representation, an acceptable result can still be acquired with a very small suitability-score difference.

Besides, in FIG. 15, it is noticed that there are 6 test time series data for the 3^{rd} suitable representations. Only two representations (i.e. DWT and PAA) are selected as the most suitable representations under that setting (see FIG. 13). Such a result shows that there are other representations applicable to these 6 test time series data. After careful study, it can be found that DCT is the 3 most suitable representation for the 6 test time series data while the 2^{nd} is suitable for the rest 3 test time series data. It shows that these 6 test time series data cannot find similar representative prototypes of time series data from the training time series data. To solve this problem, the present invention proposes a solution of specifying a threshold to extend prototype.

### [Actual Test Data]

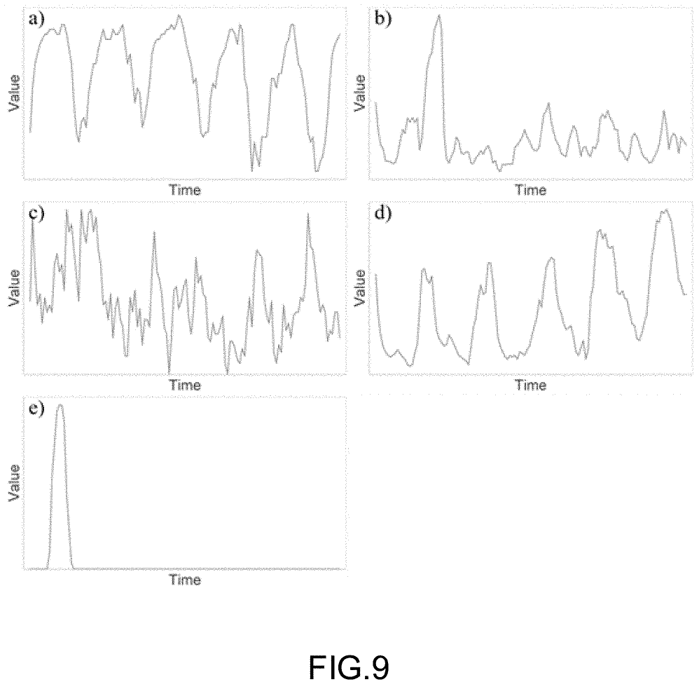

For a more comprehensive evaluation, the present invention collects time series data from an actual data service platform, which platform provides publicly available high-quality sensor observations, including air quality, disaster events, and water resources. The present invention selects five different time series datasets for testing, which are of temperature, humidity, wind speed, PM2.5, and rainfall. For each of these five time series data, six different segments with the same data length of 128 are randomly selected to form a total of 30 actual test time series data. Each of the original time series data are shown in FIG. 9, where Diagram (a) shows the hourly humidity data of the first area; Diagram (b) shows the hourly PM2.5 data of the second area; Diagram (c) shows the hourly wind speed data of the first area; Diagram (d) shows the hourly temperature data of the first area; and Diagram (e) shows the rainfall data of the first area per 10 minutes (min). Besides, the training time series data is still obtained from the UEA and UCR time series classification database.

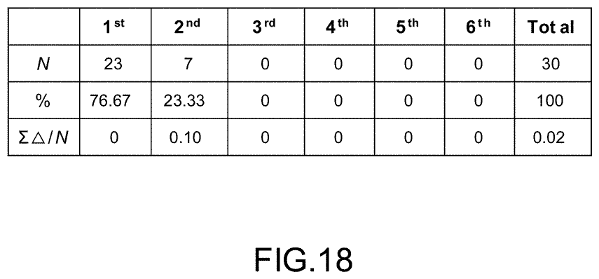

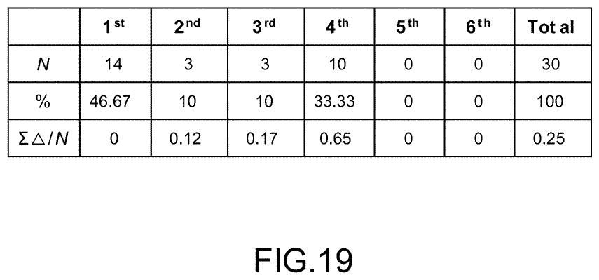

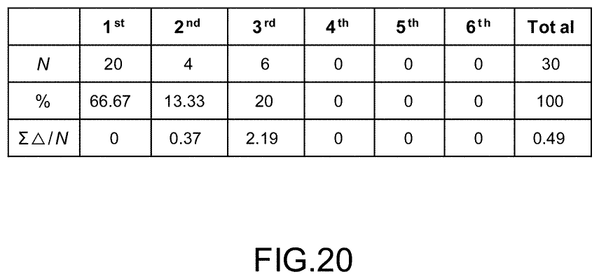

The accuracy analysis results obtained from the actual UEA and UCR time series classification database under three different weight settings are shown in FIG. 18, FIG. 19, and FIG. 20. As compared with the results in FIG. 15, FIG. 16, and FIG. 17, the results are similar, even better. For example, the result in FIG. 18 shows that the present invention has a 76.67% chance to select the most suitable representation for time series data under the first setting. Hence, the present invention achieves stable accuracy even for data from different sources.

### (C) Efficiency Analysis

As described above, prior arts test different time series representations one by one for determining the most suitable representation. Although guaranteeing the most suitable representation, the prior arts are very time consuming on dealing with a large amount of time series data. For comparing the present invention with the prior arts on performance in terms of processing time, the present invention experiments with the prior arts and the present invention under different data lengths (128, 256, 512, and 1024). With sensor data collected every five minutes, 1024 data lengths are observed in 3.5 days; yet, with sensor data collected every hour, a data length of 1024 would describe observations over one month.

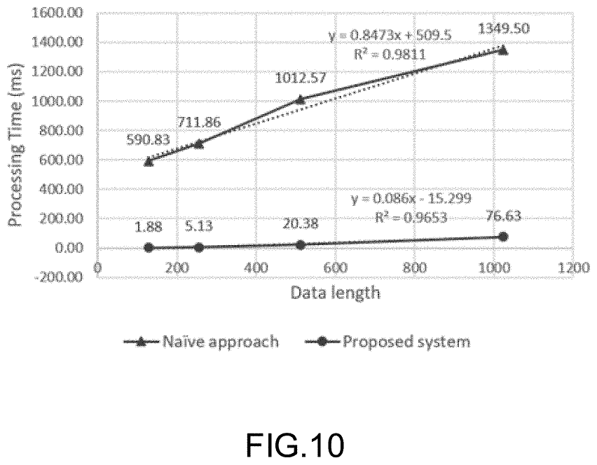

An evaluation test is conducted on a computer equipped with Intel 2.9 GHz CPU accompanied with 8 GB RAM. For each data length, the present invention tests 850 times, whose average result is shown in FIG. 10. As shown in the figure, the present invention is much faster than the prior arts, where the acceleration rate of processing time is almost 10 times slower than the prior arts. For the data length of 128, the processing time of the present invention is 300 times faster than the prior arts on average. Even for the data length of 1024, the present invention is still 17 times faster than the prior arts on efficiency.

As the result shows, for the data length of 1024, the absolute difference in processing time between the prior arts and the present invention is about 1 second. Nevertheless, in many application processes, the present invention may need to process thousands of time series data simultaneously. On using such a large amount of time series data, the present invention saves a lot of time and provides a result of acceptable representations.

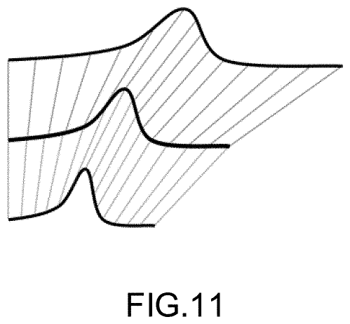

Besides, the time complexity of DTW is O (mn), which means that, on dealing with larger data length, the processing time of the present invention increases exponentially. Despite of a high time complexity, DTW still has advantage. DTW can calculate the similarity between two time series data having different lengths. Under this circumstance, the present invention can store a shorter prototype data length to calculate the similarity for a longer new time series data length. For example, an input time series data may have the length twice of the prototype in the present invention; but DTW can still distinguish the strong similarity contained within, whose example is shown in FIG. 11.

In particular, the present invention mainly proposes a high-efficiency apparatus to identify representation for heterogeneous time series data. The apparatus accords with the requirements of compression rate and information loss on finding out a most suitable time series representation for a specific time series data. A model training device processes performance evaluations of different representations with each training time series data for further determining the most suitable representation for the training time series data. For further improving the efficiency of the apparatus, training time series data are clustered and the most representative time series data for each clustered data is determined. Then, whenever the apparatus receives unidentified time series data, a data classification device computes the similarity between the unidentified time series data and each cluster representation to indirectly identify the most suitable representation for the unidentified time series data. As shown in the experiment results, under different settings of parameters, the present invention identifies the most suitable representations for 46% to 76% time series data. For the rest of the time series data, the representation selected by the present invention has a difference smaller than 2.19% to the most suitable representation in actual. Besides, regarding identifying most suitable representation, the efficiency is 17 to 300 times faster than those of prior arts and the scalability is 10 times to those of the prior arts.

Overall, the present invention is characterized in the following:

1. Based on the requirements for different users, like high compression rate, low distortion rate, good compression rate, balanced distortion rate, etc., a most suitable time series representation is identified.

2. As compared with prior arts as testing different time series representations one by one, the present invention reaches an efficiency of 17 to 300 times on identifying the most suitable time series representation.

To sum up, the present invention is an apparatus of identifying representation with high efficiency for heterogeneous time series data, where a plurality of time series representations are tested to find out one of the time series representations as most representative for specific time series data; and, on receiving new time series data, a comparison with the representative time series data is processed to determine the most similar time series data and representation.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An apparatus of identifying representation with high efficiency for heterogeneous time series data, comprising
a model training device,
wherein a suitability score is obtained with a weighted sum of compression rate and information loss to evaluate the performance of various time series representations for each training time series data to thus identify a most suitable time series representation for said each training time series data; and, then, said training time series data are clustered and a most representative time series data is determined for each clustered data; and
a data classification device,
wherein said data classification device connects to said model training device; on receiving new time series data unidentified, a comparison with said representative time series data is processed to compute similarity between said new time series data and each item of said representative time series data in said clustered data through distance measure to classify said new time series data; and said most suitable time series representation is thus indirectly identified for said new time series data.

2. The apparatus according to claim 1,
wherein said model training device comprises a training data unit; a representation determination unit, connecting to said training data unit; a clustering unit, connecting to said representation determination unit; and a prototype extraction unit, connecting to said clustering unit.

3. The apparatus according to claim 2,
wherein said training data unit provides each time series with training datasets and testing datasets through a time series classification database; and said training datasets are obtained as training time series data to process evaluation with said testing datasets.

4. The apparatus according to claim 3,
wherein, before said training data unit processes said training time series data, normalization of minimum and maximum is processed to normalize values of said training time series data into a range of 0˜100.

5. The apparatus according to claim 2,
wherein said representation determination unit has six of said time series representation; each of said training time series data obtains four data lengths (128, 256, 512, and 1024) and five coefficients (2, 4, 8, 16, and 32) to test each of said time series representations, which is applied to compression rate and information loss of said each of said training time series data; 20 combinations of said each of said time series representations corresponding to said each of said training time series data are obtained; through processing said weighted sum, an average value of 20 ones of said compression rate and 20 ones of said information loss is computed to obtain a suitability score having a range of 0˜100 to evaluate the performance of one of said time series representations to one of said training time series data; and one of said time series representations having the biggest suitability score is thus determined as a most suitable time series representation of said training time series data.

6. The apparatus according to claim 5,
wherein said six of said time series representation comprises a discrete Fourier transformation (DFT) representation, a discrete cosine transformation (DCT) representation, a piecewise aggregate approximation (PAA) representation, a piecewise linear aggregate approximation (PLAA) representation, an adaptive piecewise constant approximation (APCA) representation, and a discrete wavelet transform (DWT) representation.

7. The apparatus according to claim 2,
wherein, before said clustering unit processes clustering, each item of said training time series data is clustered based on a most suitable time series representation thereof so that all of said training time series data in a clustered data have the same suitable one of said time series representation; and, then, a distance measure of dynamic time warping (DTW) is processed to identify said training time series data having similar characteristics.

8. The apparatus according to claim 2,
wherein said prototype extraction unit obtains a medoid as a prototype for each clustered data; on retrieving said prototype, said training time series data in a clustered data are obtained to compute the distances between all pair items of said training time series data; in all of said training time series data, one item of said training time series data having the smallest sum of distances to the other training time series data is defined as the center of said clustered data to thus obtained a most representative time series data for each said clustered data.

9. The apparatus according to claim 1,
wherein said data classification device comprises a similarity computation unit and a representation execution unit connecting to said similarity computation unit.

10. The apparatus according to claim 9,
wherein, through a distance measure of DTW, said similarity computation unit calculates similarity between new time series data unidentified and representative time series data obtained through clustering and prototype extraction to find out a most similar item of said training time series data and a most suitable one of said time series representation of said most similar item of said training time series data; and an assumption that said most similar item of said training time series data is the same as a most suitable time series representation of said new time series data is made to thus indirectly identify said new time series data with said most suitable time series representation.

11. The apparatus according to claim 9,
wherein said representation execution unit obtains one of said time series representation identified to process compression to said new time series data.
